(19) United States
(12) Patent Application Publication
(10) Pub. No.: US 2005/0267804 A1
(43) Pub. Date: Dec. 1, 2005

(54) Coupon dispensing methods and systems

(76) Inventors: John Lonsbury, Edina, MN (US); Mark Lonsbury, Minneapolis, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 11/082,226

(22) Filed: Mar. 16, 2005

Related U.S. Application Data
(60) Provisional application No. 60/553,496, filed on Mar. 16, 2004.

(51) Int. Cl. G06F 17/60

(52) U.S. Cl. 705/14

(57) ABSTRACT

A coupon dispensing system is provided, and includes a plurality of dispensing devices located in retail establishments, wherein each dispensing device includes a kiosk unit. The kiosk unit includes a processing unit, a touch screen display, a modem and/or network connection, and a storage device. Also provided is a control system capable of exchanging information with the dispensing devices, wherein the control system includes software operable to maintain library of coupon offerings, send coupon offering information to dispensing devices, collect and operate on data received from coupon dispensing devices, provide a web interface accessible over the Internet to provide for viewing of selected dispensing system data. Also provided is a coupon offering authoring tool to prepare coupon offering data to be used to display coupon offerings by the dispensing devices. In the above embodiment, the retail establishment offers a product or service or entertainment to a consumer. According to various methods of the inventive subject matter disclosed herein, a coupon dispensing device is located in a retail establishment and displays a selection of coupon offerings on a graphical display, wherein the coupons are for goods or services offered for sale at the retail establishment. The coupon offerings are displayed in two or more groups, wherein one group is displayed at a time. A consumer operating the dispensing device can sequence through displays of groups on the display.

### TECHNICAL FIELD OF THE INVENTION

The present invention pertains generally to programmed computers and more particularly to methods, articles and apparatus for dispensing coupons.

### BACKGROUND OF THE INVENTION

Product or service redemption coupons are regularly used by millions of consumers who realize substantial savings as a result. One use of product redemption coupons is to entice consumers to try new products in the hope that, after the first try of a new product at a coupon discounted price, they would become repeat customers at the regular price. Coupons are effective tools used in launching new products. Manufacturers also find coupons can shore up flagging sales, help reduce excess inventory or win back consumers' brand loyalty. As a result, coupons for existing products have become customary, so much so that today's consumers have come to expect coupons. The competitive nature of the retail industry does not allow manufacturers to reduce coupon distribution, and in some market sectors, such as cereals, the majority of purchases are made with coupons.

Coupons are delivered to consumers through a variety of media. The primary coupon distribution is via pull-out sections in newspapers, which are known as free standing inserts (FSIs). By some estimates, these FSI coupons account for over one half of coupons used. Other methods of distribution include in-store shelf coupon dispensers, check-out coupons (generally issued based on the customer's current purchase), register receipt coupons, in-product coupons, instant peel-off on-product coupons and direct mail coupons. In addition to manufacturers' coupons, consumers use retail store coupons, such as those issued by large retail chains, on a weekly basis.

Some consumers use coupons on a fairly random basis. These consumers tend not to keep coupons for future use, but will review coupons available just prior to shopping to see if any of them cover products they plan to buy or if there are any for new or improved products of interest. More organized coupon users maintain some form of storage system to keep coupons for future use. These consumers often clip coupons regularly from all available sources, and often have coupon-filing systems by product category. They will also review their coupons regularly, discarding unused coupons, which have expired.

For most consumers, attempts to maintain an organized coupon file often fail. The “bother” and time required to maintain organized coupon files often results in neglect of those files, even though diligent shoppers know that a consistent significant savings is easily achievable using coupons.

On average, manufacturers who use FSls for coupon distribution, the largest percentage of coupons distributed, spend nearly one dollar per coupon redeemed, which is the lowest redeemed cost per coupon redeemed when compared with other current coupon distribution methods. FSI coupon distribution results in high costs per coupon because of the shear complexity of and volume of materials involved in coupon distribution and redemption. Charges to manufacturers by FSI producers cover set-up, paper, printing, freight, newspaper insertion costs, sales and marketing, overhead and profit.

Direct mail coupons, Run-of-Press (“ROP”) Coupons, in/on pack coupons are other forms of coupon distribution. Two other important coupon distribution methods include shelf distribution and custom prepared coupon distribution. Thousands of stores use coupon dispensers, which are attached to a product's shelf Customers can pull out one coupon from the dispenser for the product advertised. This method of coupon distribution is designed to reach the consumer at the point of making a purchase decision, and has a relatively high redemption rate. Another approach is check-out coupons that are printed at the check-out by a printer installed at the cash register. A computer analyzes the purchases made by each customer, and can print competitor's coupons or other coupons related to items in the current purchase.

As demonstrated above, the coupon industry expends a great deal of resources in market research, printing, issuing, distributing and redeeming coupons, yet produces an extremely low redemption rate. This is attributed to the haphazard systems used by most consumers of manually clipping, filing, sorting through, and ultimately using the coupons, and to the high cost associated with targeting coupons to each consumer.

### BRIEF DESCRIPTION OF THE DRAWING

FIGS. 1-19 illustrate various alternate embodiments of the inventive subject matter disclosed herein.

### DETAILED DESCRIPTION OF THE INVENTION

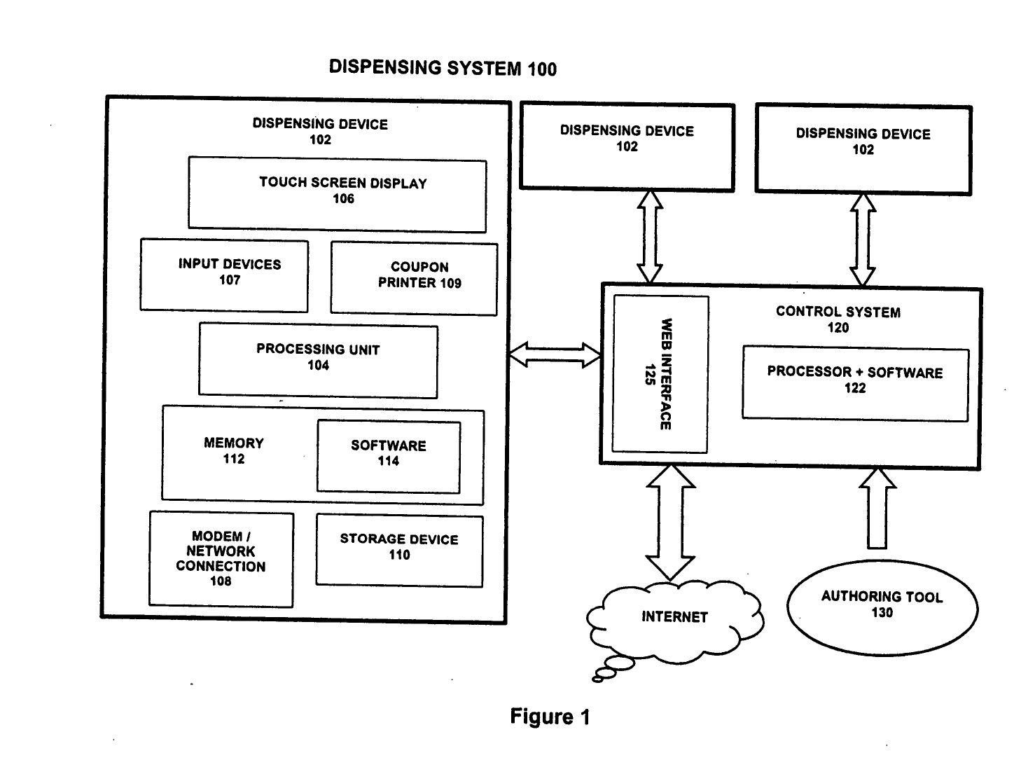

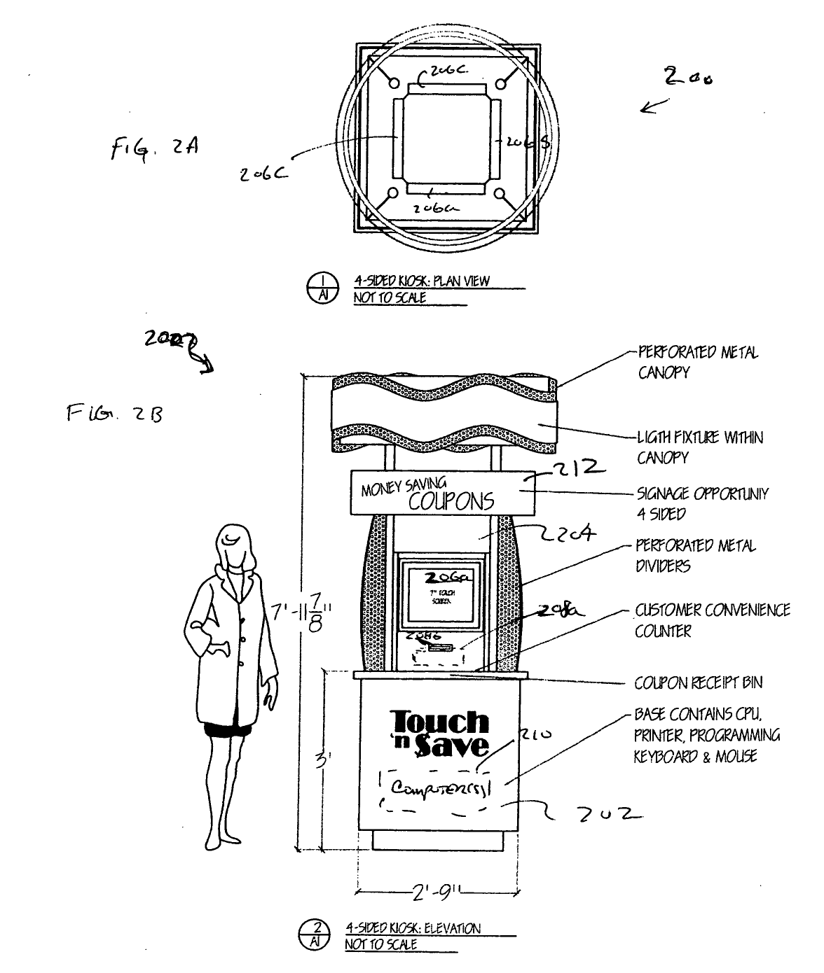

Referring now to FIG. 1 there is illustrated a block diagram of a coupon dispensing system 100 according to one example embodiment of the inventive subject matter presented herein. A plurality of dispensing devices 102 are located in retail establishments, wherein each dispensing device takes the form of a kiosk unit including one or more processing units 104, one or more touch screen display(s) 106, one or more input devices 107, one or more modems and/or network connections 108, one or more coupon printers 109, a storage device 110, memory 112 and software 114 executable on the processing units 104 and stored in the storage devices 110, memory 112 or in another storage locations on device 102. It is noted that the term “retail establishment” as used herein means any establishment in which a product or service is offered to consumers of those products or services. A retail establishment may be, for example and without limitation, a grocery store, a deli, a restaurant, a movie theater, a clothing store, a hardware store, a service station or a fast food restaurant.

There is further provided a control system 120 capable of exchanging information with the dispensing devices 102, wherein the control system includes software 122 operable on a control system processor or processors 122 to maintain a library of coupon offerings, send coupon offering information to dispensing devices, collect and operate on data received from coupon dispensing devices, and provide a web interface 125 accessible over the Internet to provide for viewing of selected dispensing system data. Also provided is a coupon offering authoring tool 130 to prepare coupon offering data to be used to display coupon offerings by the dispensing devices. Authoring tool 130 comprises software operable on a control system processor 122 or on a separate processor found on a PC or other computer work station.

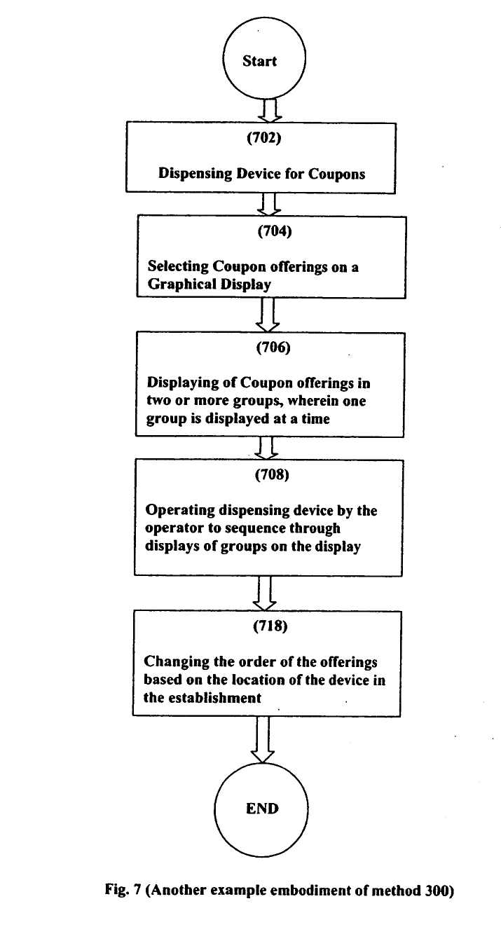

Referring now to FIGS. 2A (top plan view) and 2B (side elevation view) there is illustrated one example embodiment of a dispensing device 200. Device 200 is, in this embodiment, a kiosk available from IBM Corporation (model 152), and, referring to FIG. 2B, includes a physical housing including a lower base or pedestal portion 202 and top housing portion 204 that houses a touch screen display 206a. Device 200 includes dispensing system components such as those described above including a touch screen display 206 and a printer 208a (represented in dotted line) mounted in the housing with slot 208b providing an opening through which printed coupons can be dispensed from the printer. Dispenser 200 is, in the embodiment shown, a four-sided kiosk, and includes three additional touch screens 206b, 206c, and 206d, on the other sides, as seen in FIG. 7A. Also included but not shown are corresponding printers for each side, so that four coupon dispensing stations are provided. In this embodiment, one or more computer systems or servers 210 may be provided in base or pedestal 202 in order to operate the touch screens and associated printers.

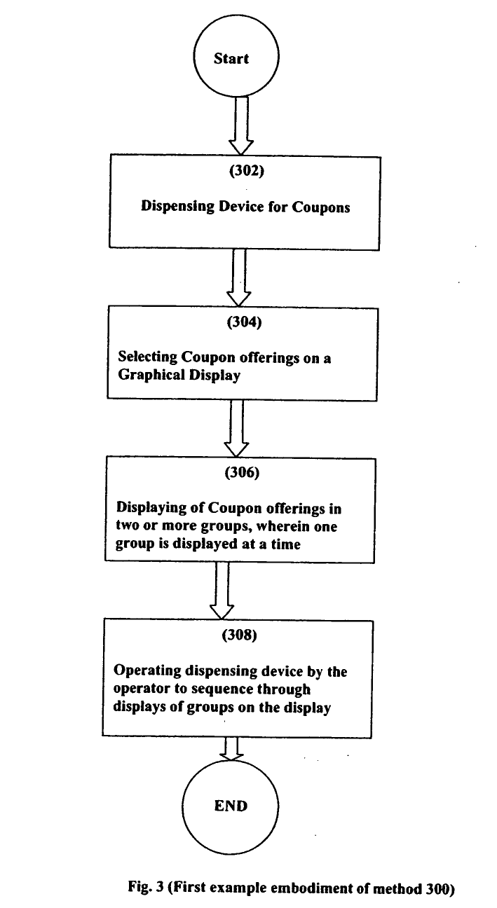

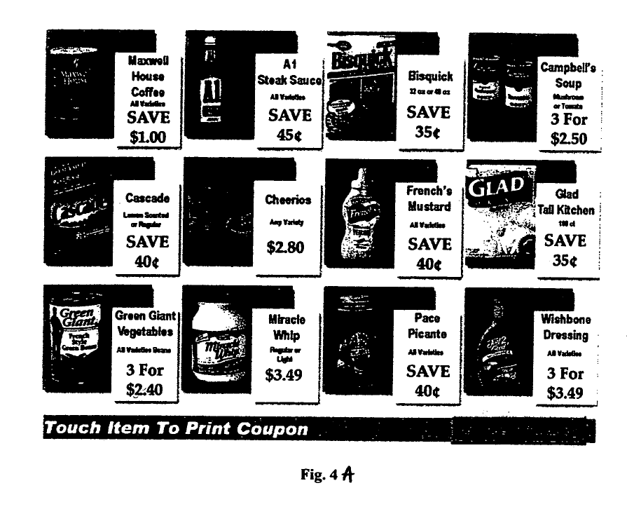

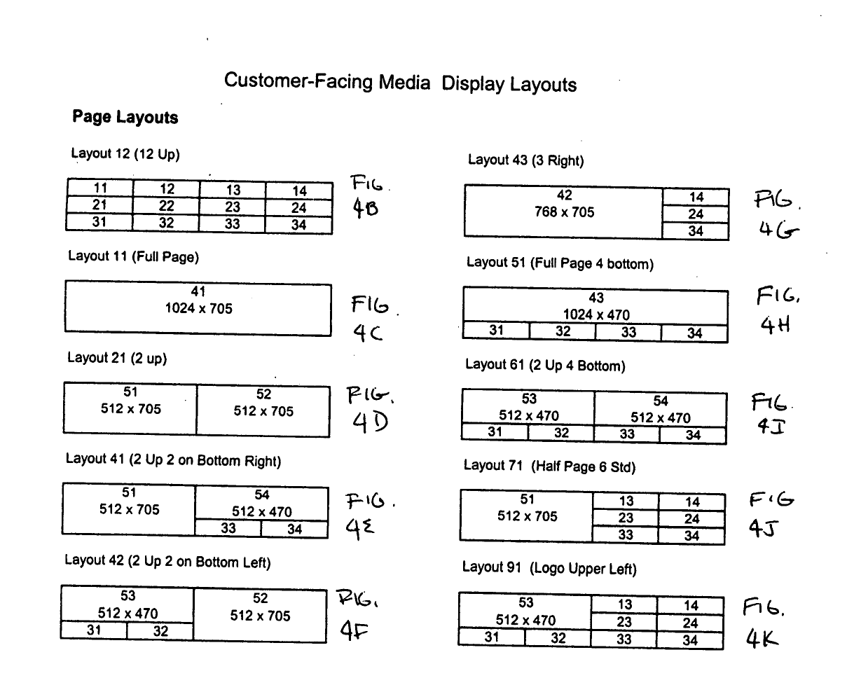

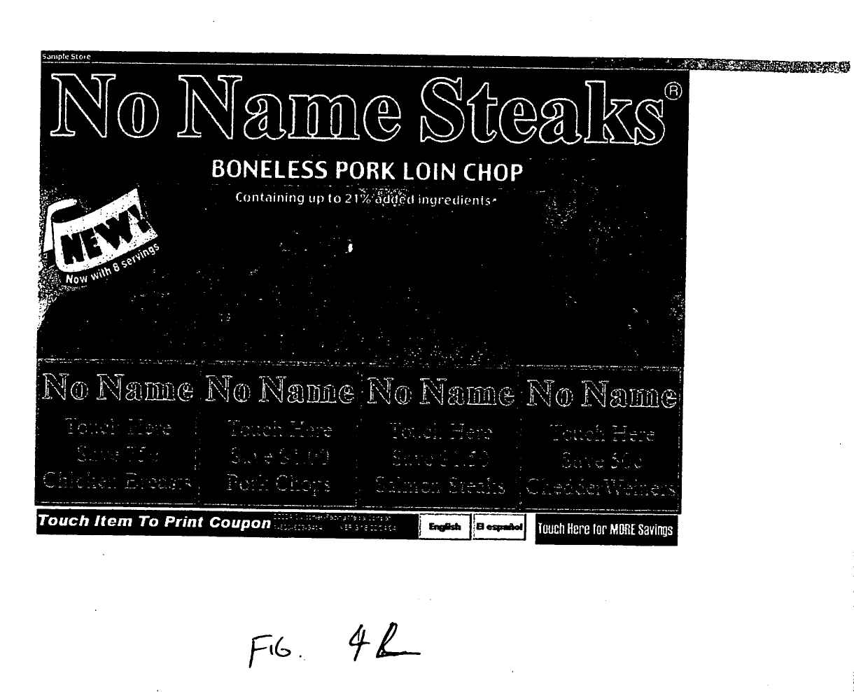

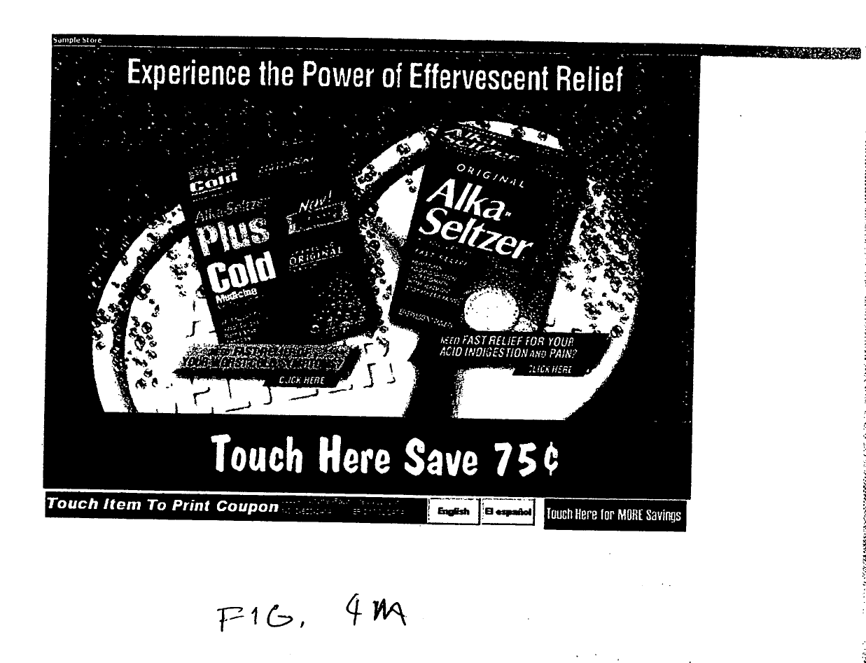

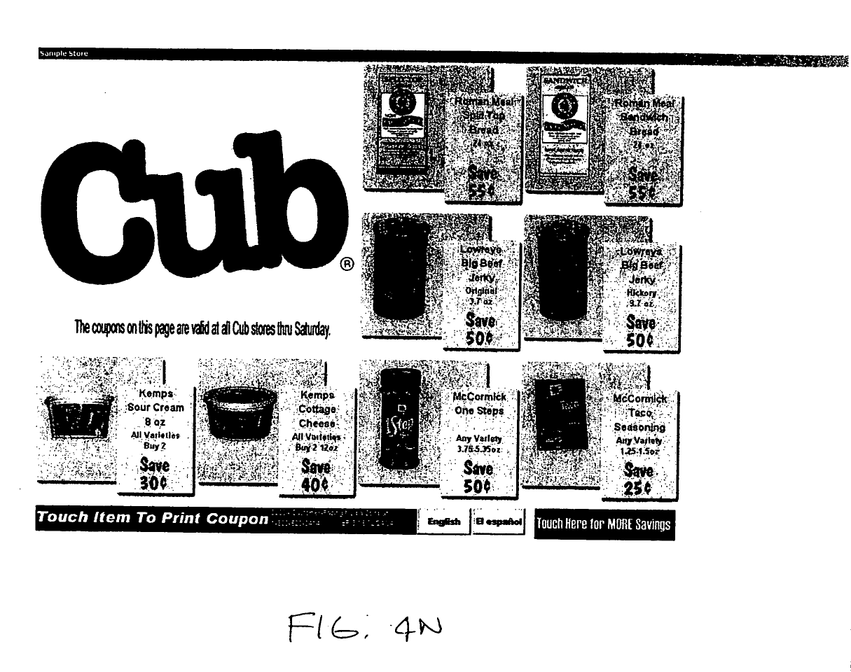

Turning now to FIGS. 3-18, there are described a number of example embodiments of methods for coupon dispensing according the inventive subject matter described here. Referring now to the flow chart diagram of FIG. 3, there is shown a first example embodiment of a method 300 according to the inventive subject matter described herein. According to this method, a coupon dispensing device is located in a retail establishment, as depicted in block 302, such as but not limited to the coupon dispensing devices described above. The dispensing device displays a selection of coupon offerings on a graphical display, as depicted in block 304, such as those shown in FIGS. 4A, 4B, 4C, 4D, 4E, 4F, 4G, 4H, 4I, 4J and 4K. FIGS. 4A and 4B illustrate a screen display with 12 coupons displayed on it in three rows of 4 coupons. FIGS. 4C through 4K show additional layouts for coupon display, where row and column is indicated by the number of the display area, and example pixel sizes are given for some areas. In the display of FIG. 4G, for example, selecting one of the coupons displayed on the right side (Spots 14, 24, 34) causes Spot 42 to display full size the selected coupon. According to this method, the coupons are for goods or services offered for sale at the retail establishment. As depicted in block 306, the coupon offerings are displayed in two or more groups, wherein one group is displayed at a time. As shown in block 308, a consumer operates the dispensing device to sequence through displays of groups on the display. For example, sequence from group 402 to group 404 to group 406.

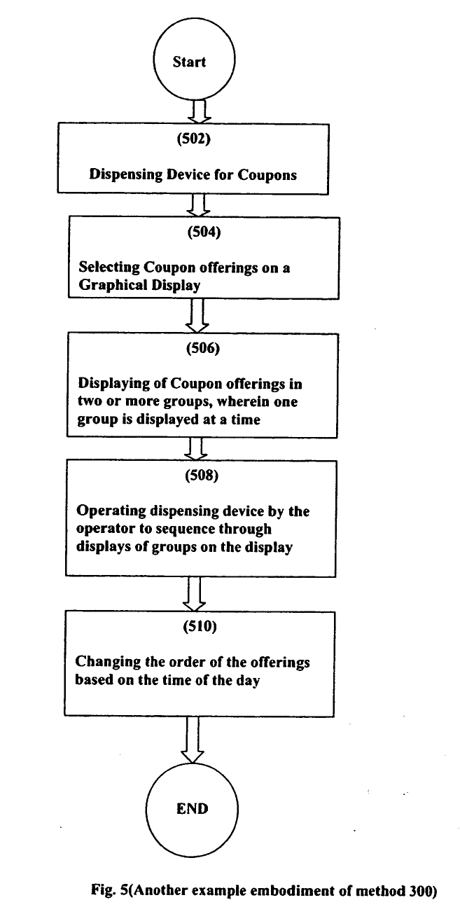

The flow chart diagram of FIG. 5 shows another example embodiment of a method 500 according to the inventive subject matter described herein. In this method, block 502 depicts a coupon dispensing device located in a retail establishment, such as but not limited to the coupon dispensing devices described above. According to this method, the dispensing device displays a selection of coupon offerings, such as those shown in FIG. 4A, 4B or 4C, on a graphical display, as depicted in block 504. According to this method, the coupons are for goods or services offered for sale at the retail establishment. As depicted in block 506, the coupon offerings are displayed in two or more groups 402, 404, 406, wherein one group is displayed at a time. As shown in block 508, a consumer operates the dispensing device to sequence through displays of groups on the display. For example, sequence from group 402 to group 404 to group 406. Further, as depicted in block 510, the offerings have an order in which those are displayed, and the order of the coupon offerings in which these are displayed, depends on time of the day. The order may also be manipulated by the software program based on several factors such as but not limited to past performance, incentive value or last offering selected.

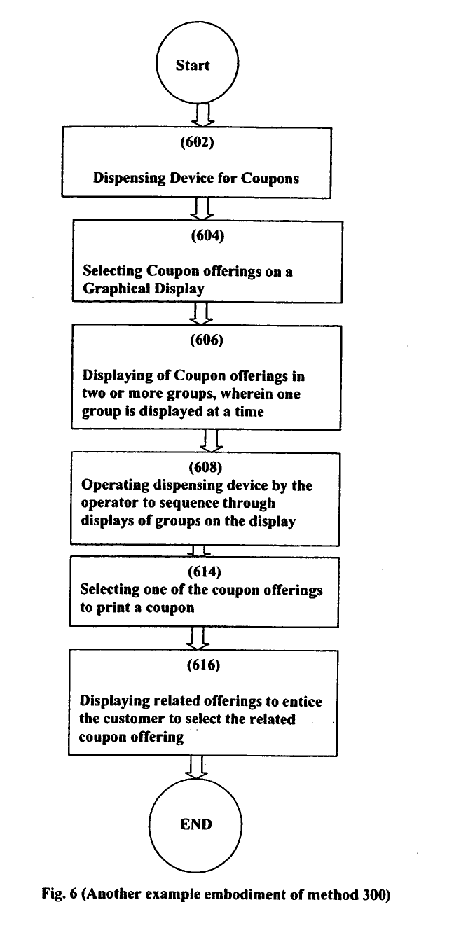

The flow chart diagram of FIG. 6 provides another example embodiment of a method 600 according to the inventive subject matter described herein. In this method, block 602 depicts a coupon dispensing device located in a retail establishment, such as but not limited to the coupon dispensing devices described above. According to this method, the dispensing device displays a selection of coupon offerings on a graphical display, as depicted in block 304, such as those shown in FIG. 4A, et. seq. According to this method, the coupons are for goods or services offered for sale at the retail establishment. As depicted in block 606, the coupon offerings are displayed in two or more groups 402, 404, 406, wherein one group is displayed at a time. According to one example embodiment, there may be instances where there is only one group displayed and the customers will select from that group only. As shown in block 608, a consumer operates the dispensing device to sequence through displays of groups on the display. For example, sequence from group 402 to group 404 to group 406. As shown in block 614, the consumer selects one of the coupon offerings to print a coupon. Such selection may be done with a touch screen by pointing to the coupon, or by other selecting operation. Further, block 616 shows that following the selection of coupon offering, a related offering is displayed to entice the customer to select the related coupon offering.

The flow chart diagram of FIG. 7 shows another example embodiment of a method 700 according to the inventive subject matter described herein. In this method, block 702 depicts a coupon dispensing device located in a retail establishment, such as but not limited to the coupon dispensing devices described above. According to this method, the dispensing device displays a selection of coupon offerings on a graphical display, as depicted in block 704, such as those shown in FIG. 4A, 4B or 4C. According to this method, the coupons are for goods or services offered for sale at the retail establishment. As depicted in block 706, the coupon offerings are displayed in two or more groups 402, 404, 406, wherein one group is displayed at a time. As shown in block 708, a consumer operates the dispensing device to sequence through displays of groups on the display. For example, sequence from group 402 to group 404 to group 406. Further, as depicted in Block 718, the offerings have an order in which those are displayed, and the order of the coupon offerings in which these are displayed, depends on location of the device in the establishment.

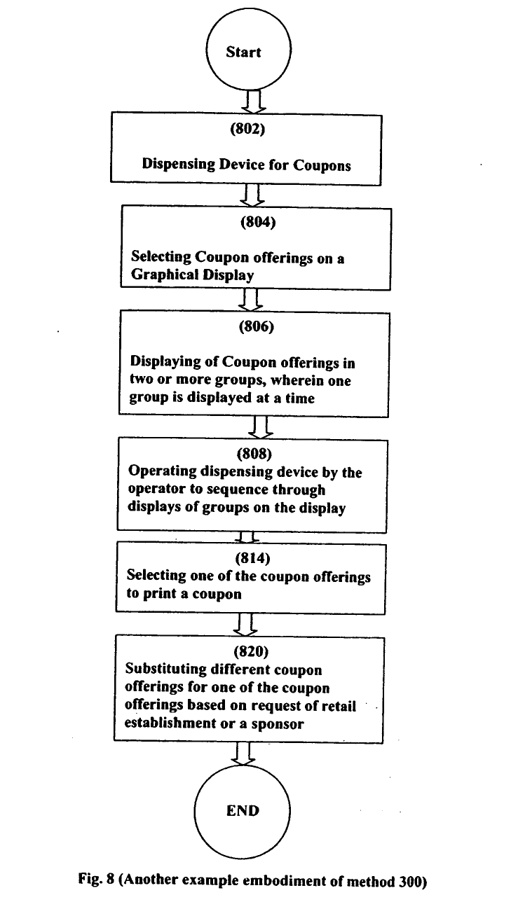

FIG. 8 is another example embodiment of the device. In this embodiment 800, a further block 820 permits substituting a different coupon offering for one of the coupon offerings based on the request of the retail establishment or a sponsor.

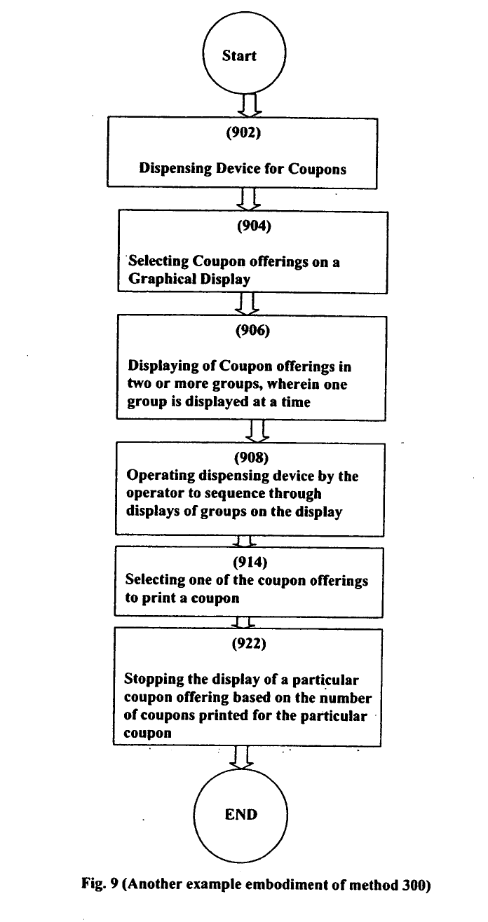

FIG. 9 is another similar example embodiment for the device. In this embodiment 900, a different block 922 permits stopping the display of a particular coupon offering based on the number of coupons printed for the particular coupon.

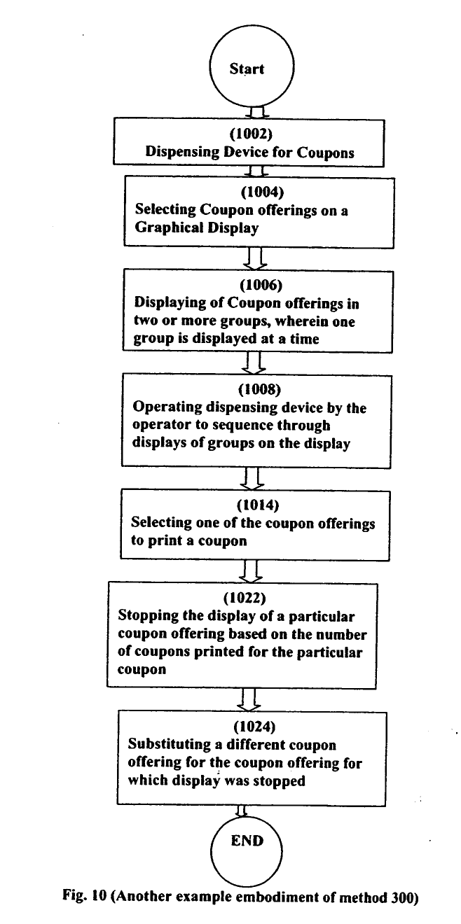

FIG. 10 is another example embodiment similar to that of FIG. 9. In this embodiment, another block 1024 depicts substituting a different coupon offering for the particular one for which the display was stopped.

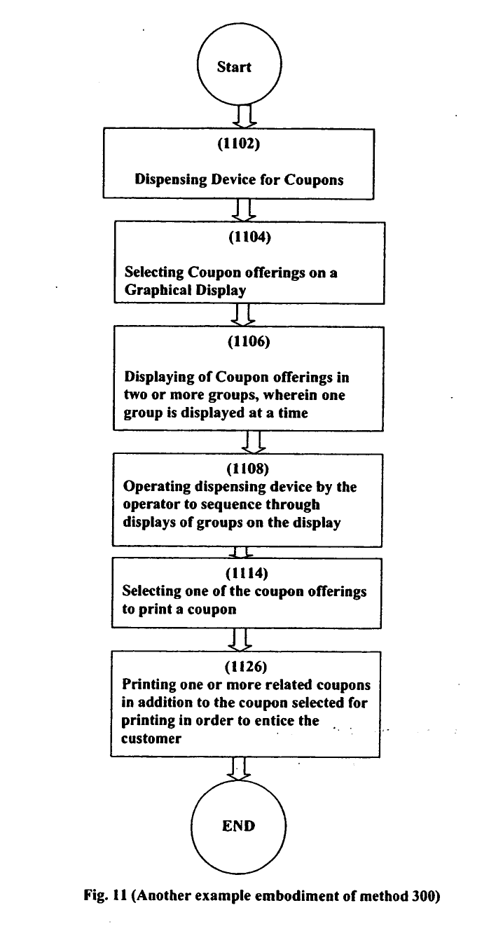

FIG. 11 is another example embodiment, and is similar to the embodiment of FIG. 6, with a different block 1126. The block 1126 permits printing one or more of related coupon offerings in addition to the selected coupon offering, to entice the customer.

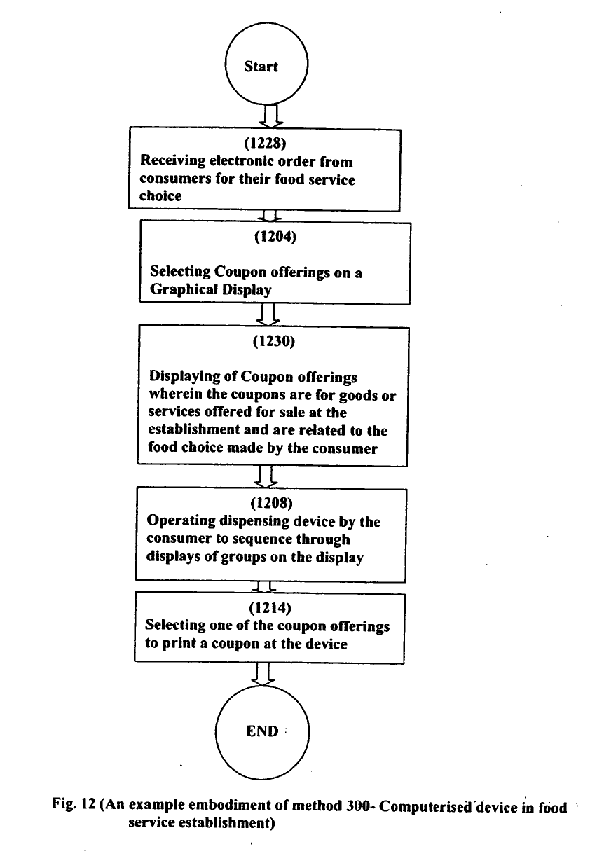

FIG. 12 is another example embodiment 1200 according to the inventive subject matter disclosed herein. A computerized device depicted by block 1228 is used for receiving electronic orders for the consumer food service choice in a food service establishment. According to this method, following entry of consumer's food choice, a selection of coupon offerings are displayed on a graphical display, as depicted in block 1204, such as those shown in FIG. 4A, 4B or 4C. According to this method, as depicted by block 1230, the coupons are for goods or services offered for sale at the food service establishment, and are related to the food choice made by the consumer. As shown in block 1208, a consumer operates the dispensing device. As shown in block 1214, the consumer selects one of the coupon offerings to print a corresponding coupon.

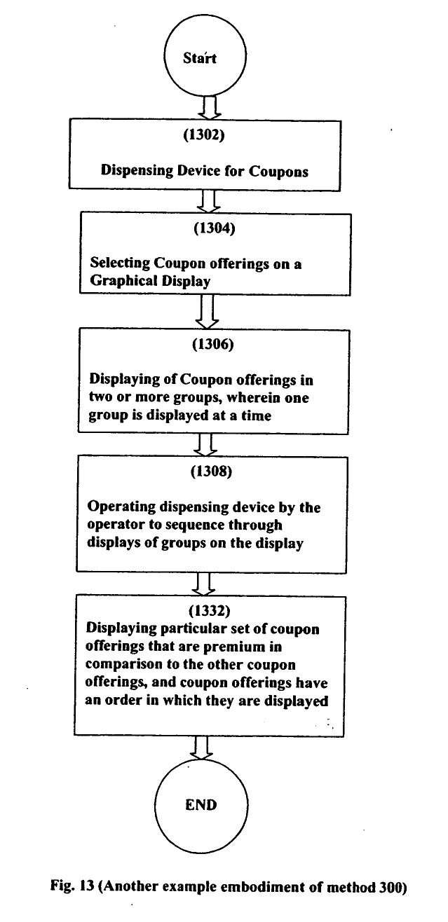

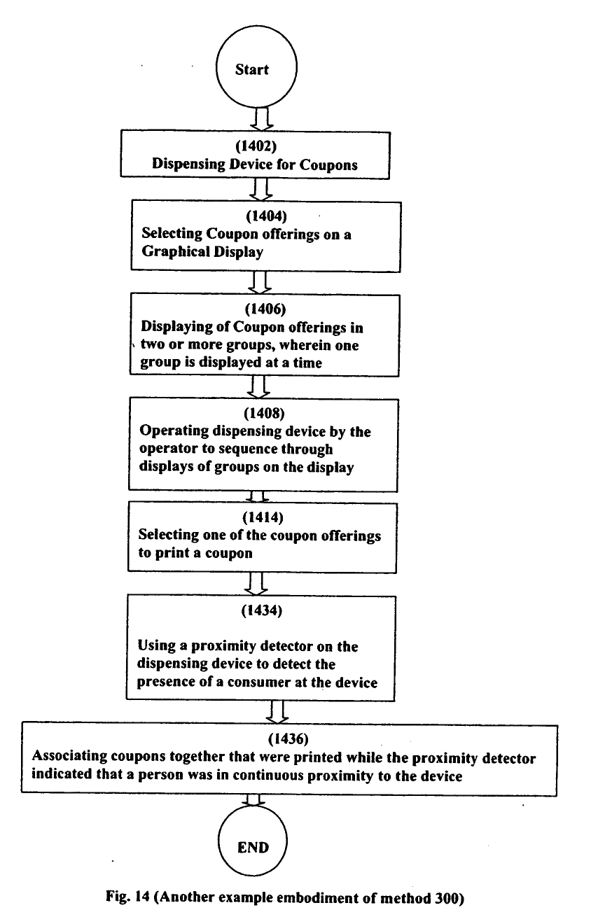

FIG. 13 is yet another embodiment of the inventive matter under consideration here. The block 1332 depicts displaying particular set of coupon offerings that are premium in comparison to the other coupon offerings with coupon offerings having an order in which they are displayed. The flow chart diagram of FIG. 14 provides another example embodiment of a method 1400 according to the inventive subject matter described herein. In this method, block 1402 depicts a coupon dispensing device located in a retail establishment, such as but not limited to the coupon dispensing devices described above. According to this method, the dispensing device displays a selection of coupon offerings on a graphical display, as depicted in block 1404, such as those shown in FIG. 4A, 4B or 4C. According to this method, the coupons are for goods or services offered for sale at the retail establishment. As depicted in block 1406, the coupon offerings are displayed in two or more groups 402, 404, 406, wherein one group is displayed at a time. As shown in block 1408, a consumer operates the dispensing device to sequence through displays of groups on the display. For example, sequence from group 402 to group 404 to group 406. As shown in block 1414, the consumer selects one of the coupon offerings to print a coupon. Further, block 1434 depicts using a proximity detector on the dispensing device to detect the presence of a consumer at the device, and block 1436 depicts associating coupons together that were printed while the proximity detector indicated that a person was in continuous proximity to the device so that coupons selected by the same or what appears to be the same person can be determined. In another embodiment, this identification is printed on the face of a coupon in a human and or machine readable format (barcode or otherwise) that could be processed later.

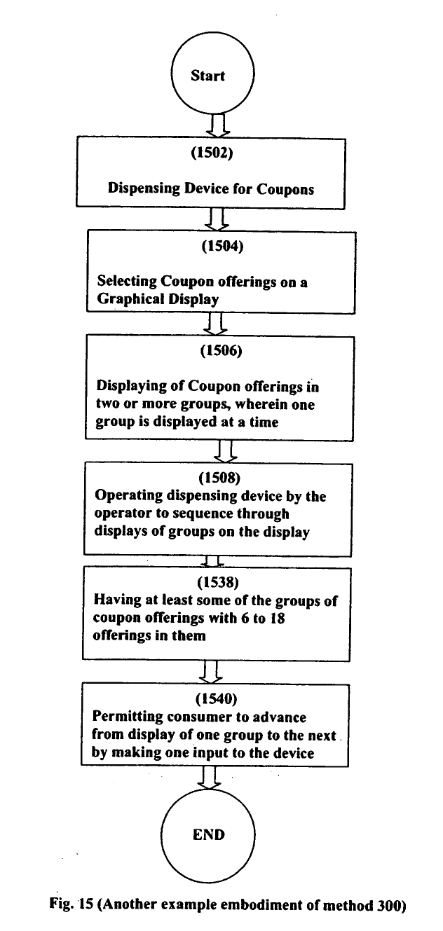

In yet another embodiment 1500 of the inventive matter under consideration here, block 1502 depicts a coupon dispensing device deployed in a retail establishment, block 1504 depicts selecting coupon offerings on a graphical display, block 1506 permits display of coupon offerings in two or more groups 402, 404, 406, wherein one group is displayed at a time. Block 1508 depicts operating the dispensing device by the operator to sequence through displays of groups on the display. For example, sequence from group 402 to group 404 to group 406. Block 1538 in this embodiment, depicts having at least some of the groups of coupon offerings have about 6 to 18 offerings in them and block 1540 depicts permitting a consumer to advance from the display of one group to the next by making one input to the device. In yet another alternate method similar to that of FIG. 15, the number of coupon offerings is about 12, the number of groups is about 3 and further wherein the one input is made by pressing a physical button on the device or a button icon on a touch screen display.

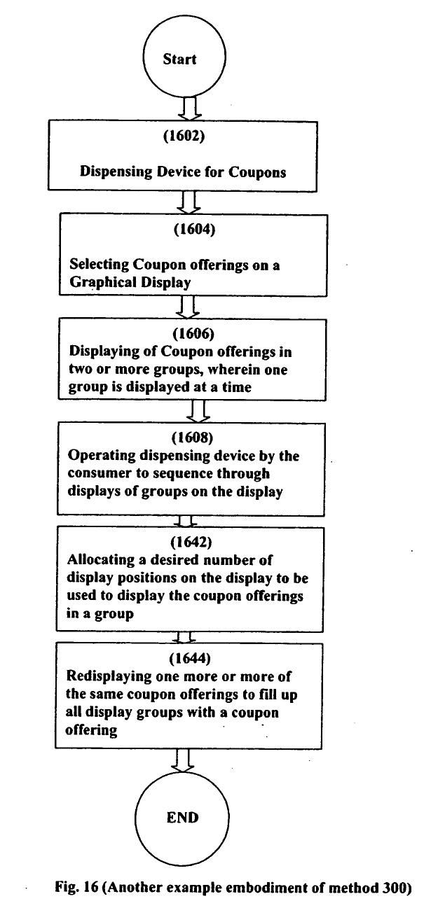

FIG. 16 is flow chart diagram of yet another embodiment 1600 of the inventive matter that is under consideration here. The additional block 1642 depicts here allocating a desired number of display positions on the display to be used to display the coupon offerings in a group. Further, block 1644 depicts redisplaying one more or more of the same coupon offerings previously displayed in a different group, if there are not enough coupon offerings available to display in the total number of display positions available while sequencing through groups of coupon offerings, so that all display groups are filled with a coupon offering. For example, if there were only 30 coupons to display but a total of 36 coupon display areas in three groups, the coupons would be rotated for display. Note that the first six coupons displayed in a first group may be repeated as the last six coupons displayed in a third group.

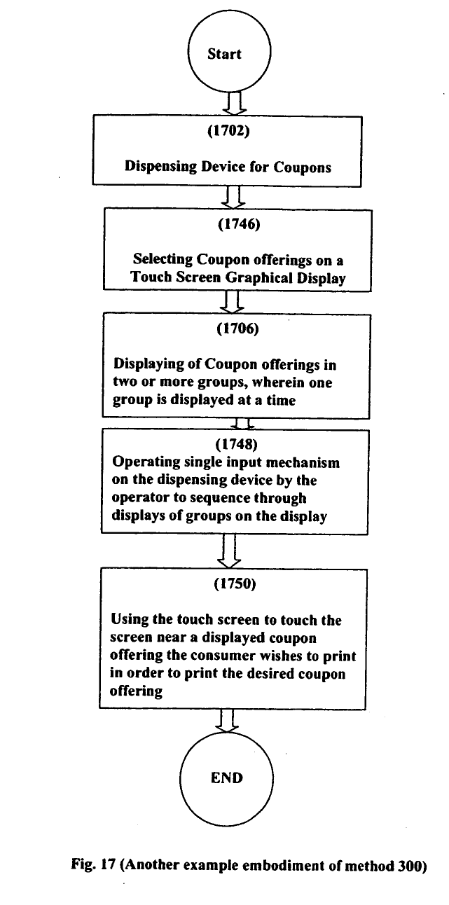

The flow chart diagram of FIG. 17 shows another example embodiment of a method 1700 according to the inventive subject matter described herein. In this method, block 1702 depicts a coupon dispensing device located in a retail establishment, such as but not limited to the coupon dispensing devices described above. According to this method, the dispensing device displays a selection of coupon offerings on a touch screen graphical display, as depicted in block 1746, such as those shown in FIG. 4A, 4B or 4C. According to this method, the coupons are for goods or services offered for sale at the retail establishment. As depicted in block 1706, the coupon offerings are displayed in two or more groups 402, 404, 406, wherein one group is displayed at a time. As shown in block 1748, a consumer operates single input mechanism on the dispensing device to sequence through displays of groups on the display. For example, sequence from group 402 to group 404 to group 406. Further, block 1750 depicts a consumer using the touch screen to touch the screen near a displayed coupon offering the consumer wishes to print in order to print the desired coupon offering.

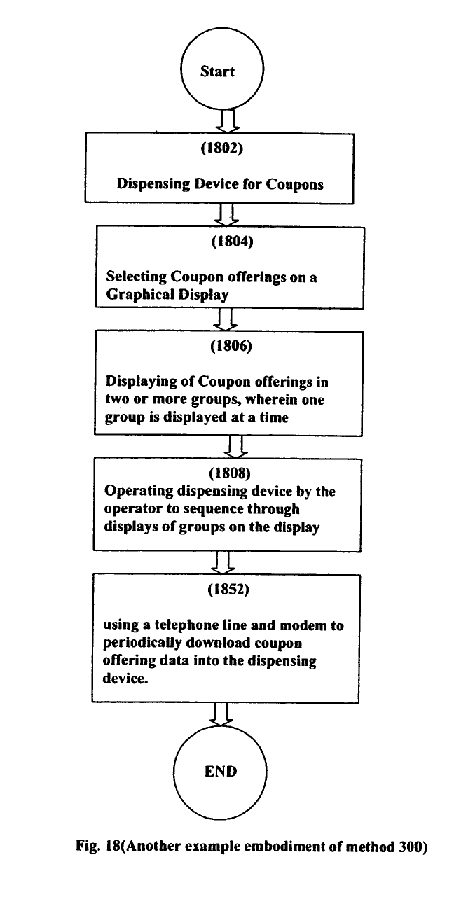

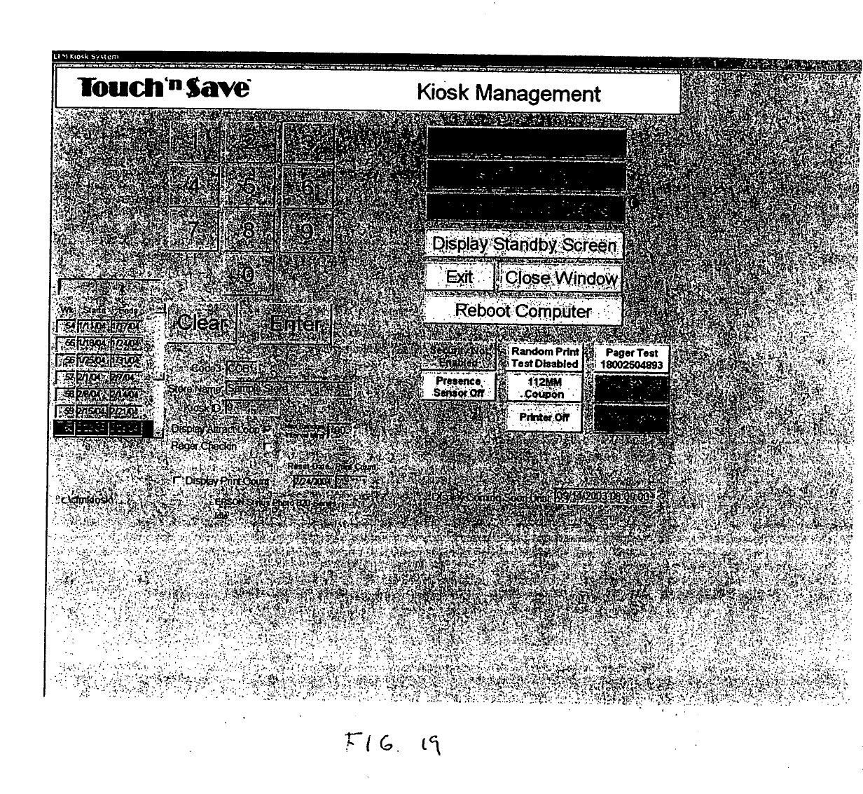

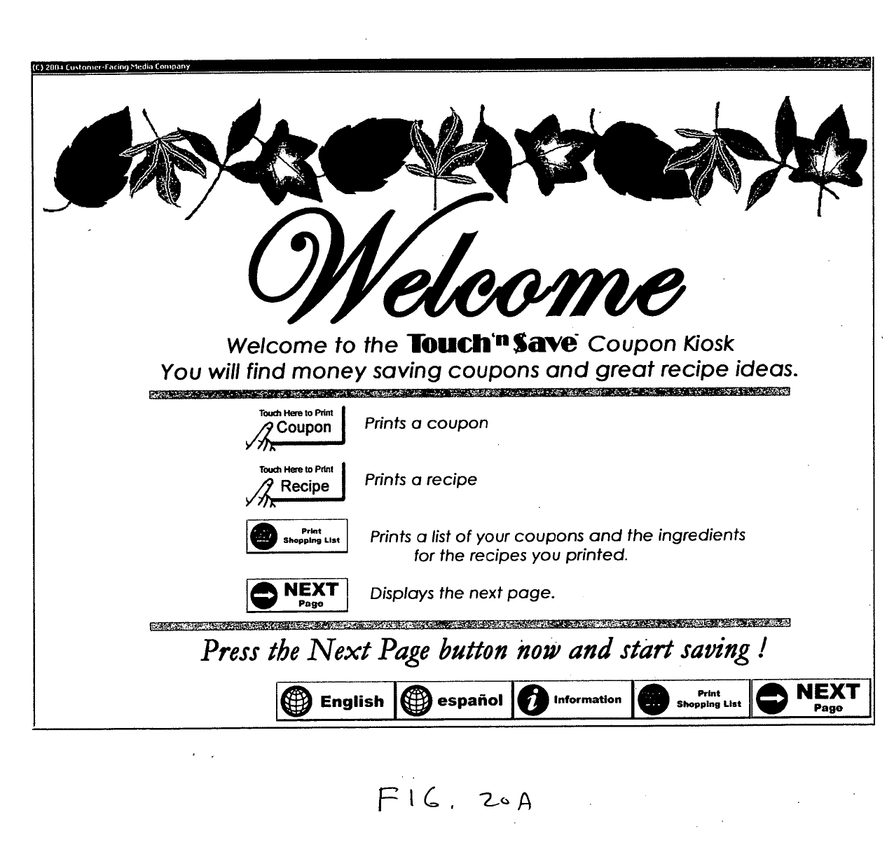

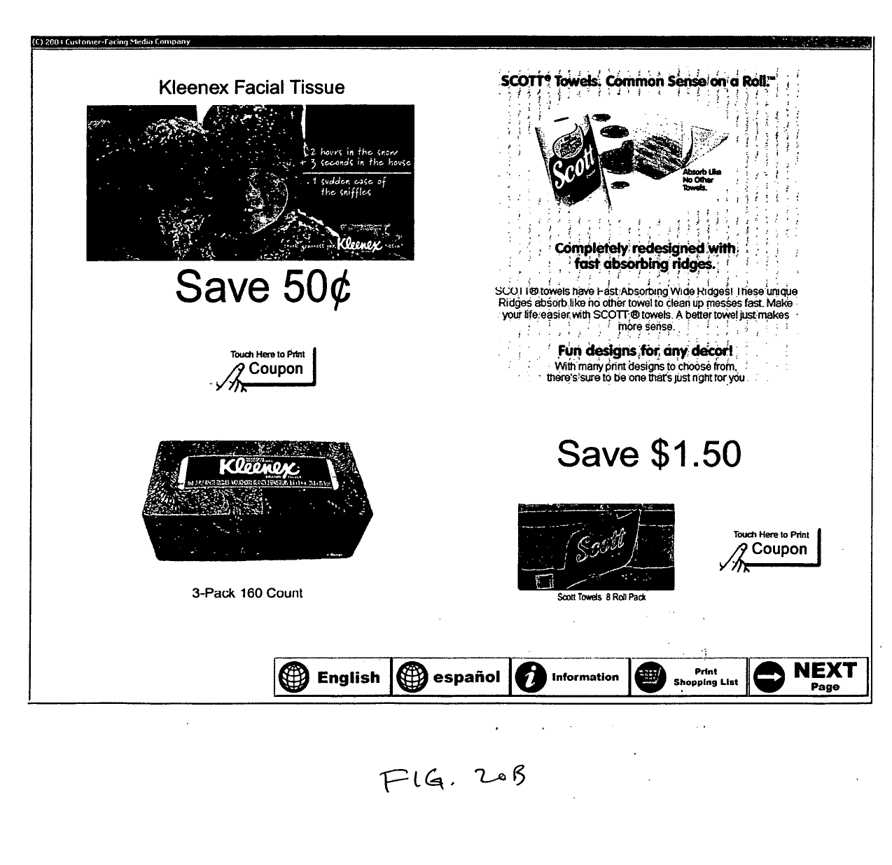

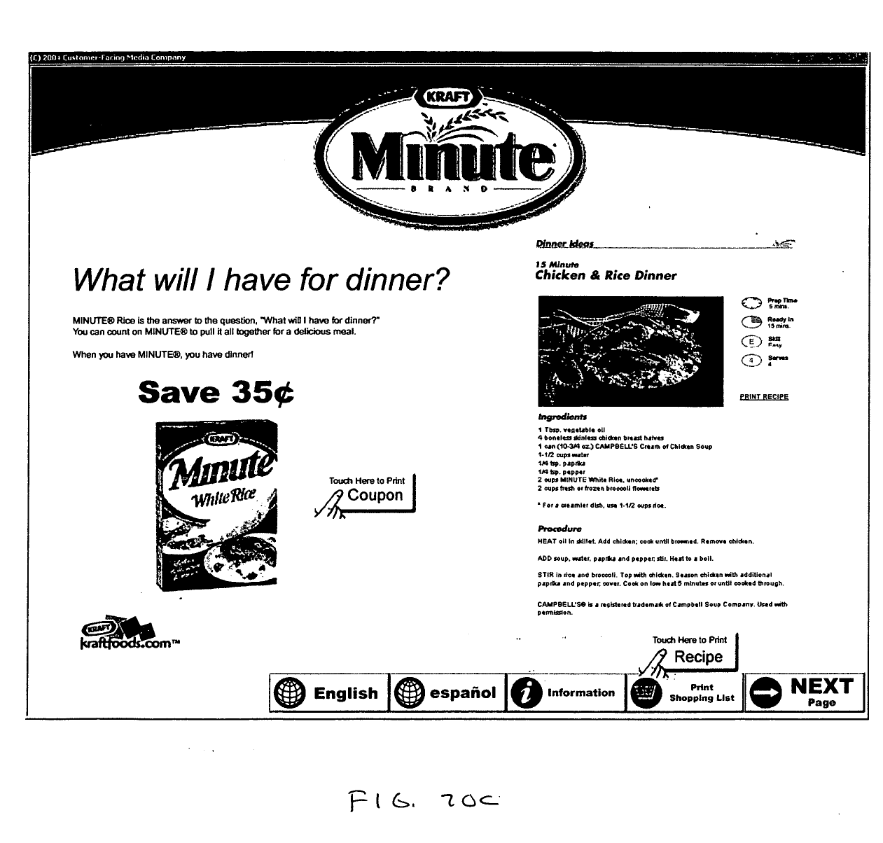

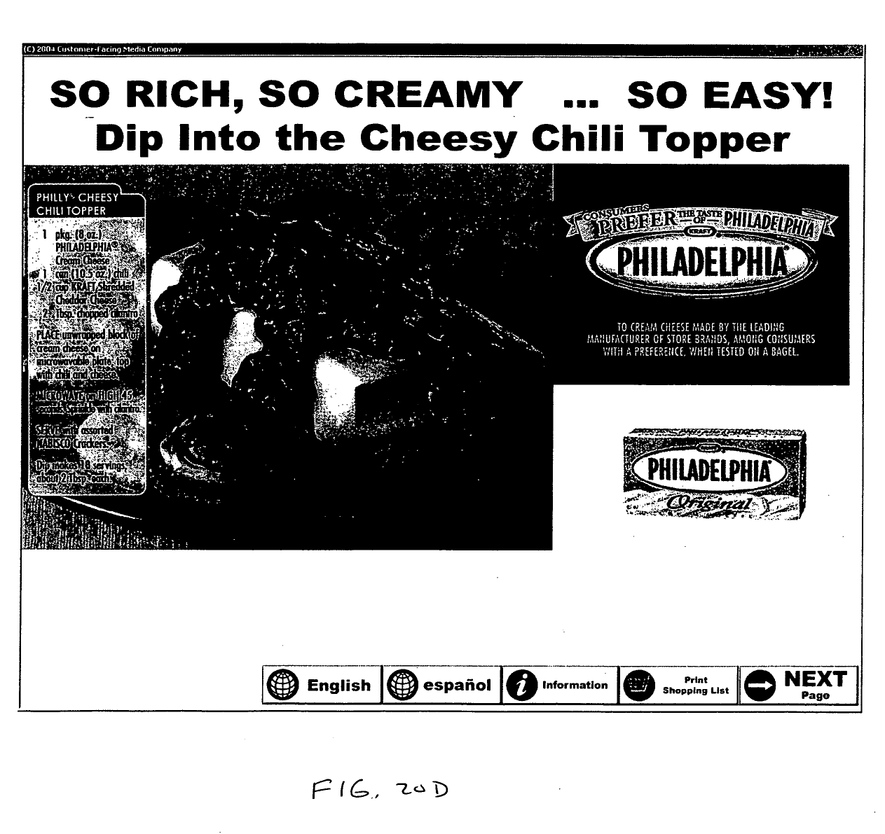

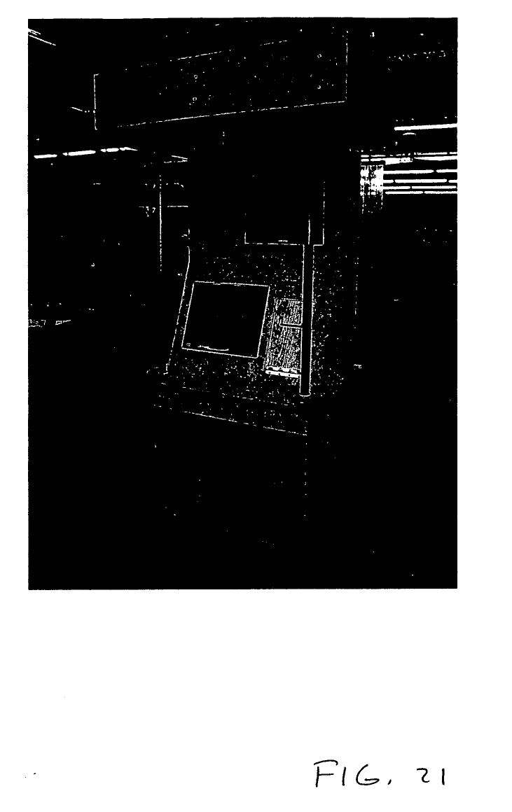

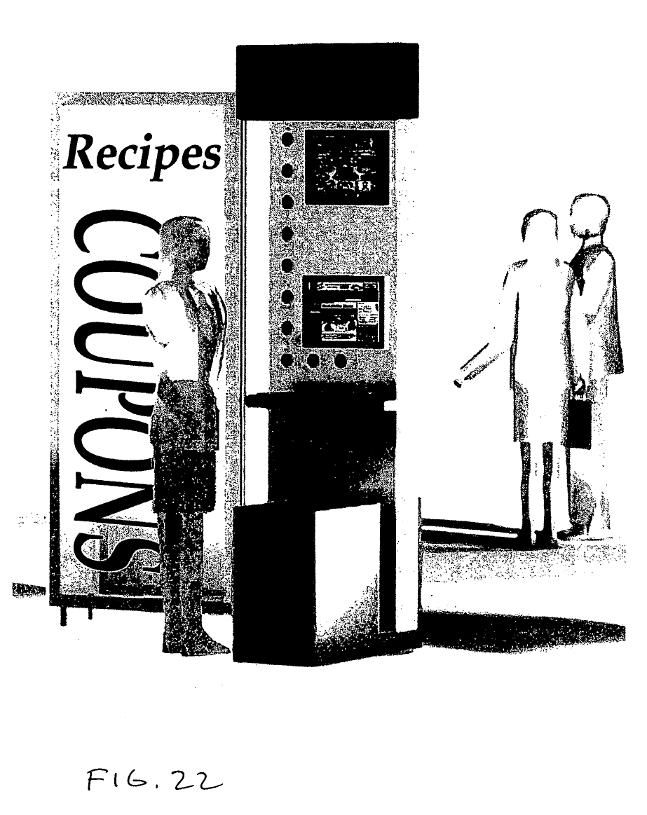

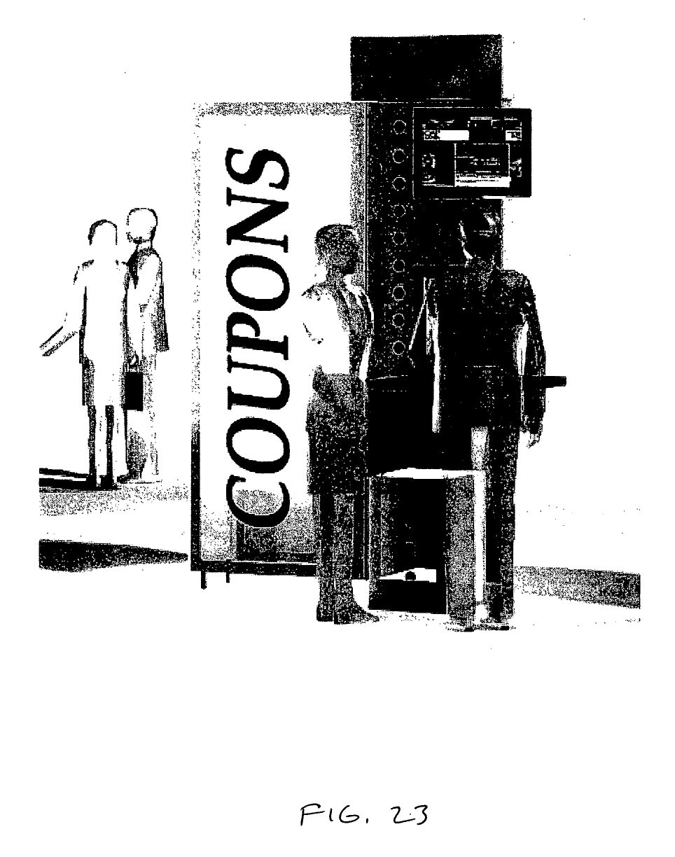

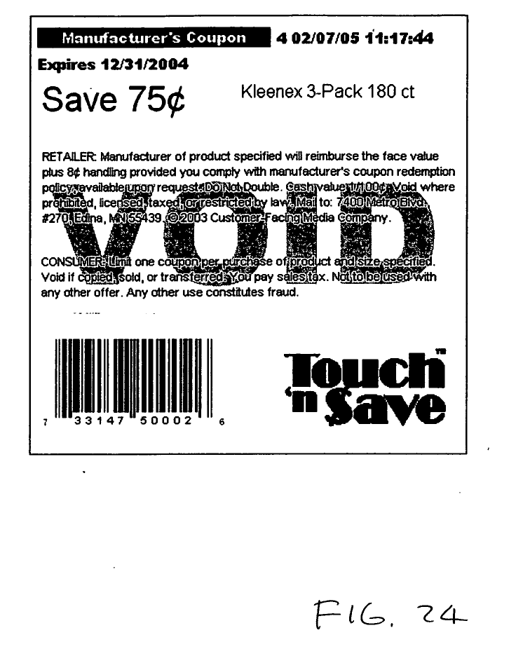

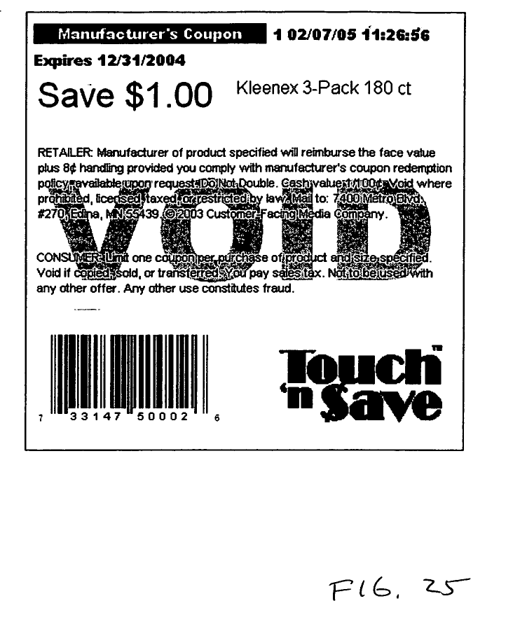

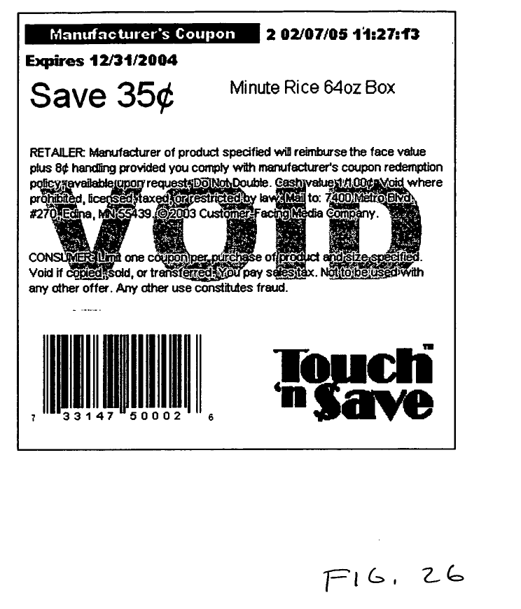

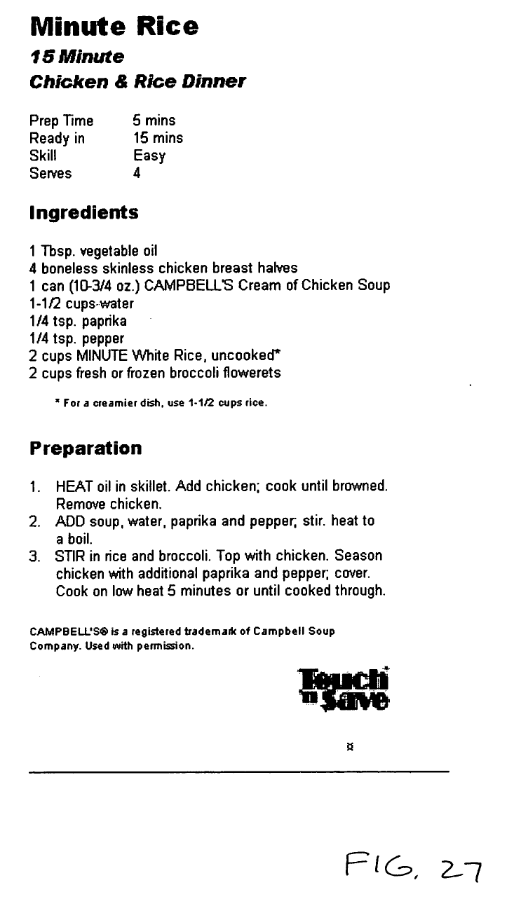

FIG. 18 is flow chart diagram of an alternate embodiment of a method according to the inventive matter under consideration here. In this embodiment, block 1852 depicts using a telephone line and modem to periodically download coupon offering data into the dispensing device illustrated in FIG. 1. According to yet another alternate embodiment, the various methods above may also include printing a coupon with a bar code that can be read by a bar code reader.

Described above with respect to FIGS. 3 to 18 are a number of alternate embodiments according the inventive subject matter disclosed herein. These methods, in one example embodiment, are implemented in whole or in part as software executable on the processing unit of a dispensing device such as device 102, and data supporting such operation is also stored in a memory or data storage component on a dispensing device, such as device 102.

According to still other example embodiments, the following features may be provided:
Display Ads
   10 page Layouts Supported
   Music/Sound—1 per page
Manufacturers Coupons
   Expiration date: enter date or days future
   Consumer/Retailer small print for each manufacturer
In Store Coupons
   Expiration date: enter date
   Consumer/Retailer small print for store chain
Display Ad while printing
   Advertising opportunity for up to four advertisers
   Includes music/sound
Ad Rotation
   Ad rotation replaces attract loop—possible with display sized ads
   Pages advance when no one is present
   Turn off presence sensor on Kiosk Management screen to bypass for demo
Other Features:
   Companion Coupon
   Dynamic Coupon
   Additional Information
      Recipe
      Nutrition information

Referring to FIGS. 20A, 20B, 20C and 20D, there is shown an alternate embodiment of screen displays for touch screen operation. The initial page shown on 20A may provide instructions for use of the system, offering the user a chance to press a NEXT Page button to view one or more successive screens showing coupon offerings, as shown in FIGS. 20B, 20C and 20D. Each screen offers a chance to print a coupon for one or more different product offerings, or offers to print a coupon for use of a product offering, along with a button for a coupon, as shown in FIG. 20C.

Referring to FIG. 21, there is shown a perspective view of a coupon dispensing kiosk or station 2100, which includes a first screen 2102 that may be used to display coupon offering touch screens, and a screen 2104 (which may be referred to a as a “marquee display”) that may be used to display advertisements, either billboard style or videos, continuously or on-demand, for example in response to a customer approaching the station 2100 as may be detected by a proximity detector supported by the housing. A printer is also located in station 2100 to print coupons or recipes or other printed materials. According to another embodiment of the system and method according to the inventive subject matter, the advertising screen 2104 displays an advertisement that corresponds to or is associated with a recipe or coupon that is selected. Alternatively, the display 2104 may be used to advertise a product or service that no coupon is offered for.

Referring to FIGS. 22 and 23, there are shown alternate embodiments of a coupon dispensing stations 2200 or 2300.

Referring to FIGS. 24, 25, 26 and 27, there are shown example embodiments of coupons or recipes 2400, 2500, 2600 and 2700, that may be printed for example in response to selection of a print coupon button on a touch screen.

According to another alternate embodiment, full page ads for a single product only may be displayed on each touch screen display.

According to still another example embodiment, the system and method of the inventive subject matter provides software adapted to execute on a coupon dispensing computer to prepare a shopping list, or simply print a stored shopping list to accompany a recipe offered on the system.

According to still another example embodiment, a navigation bar may be displayed on the touch screen displays of any of the illustrated embodiments to allow a user to jump to a desired offer for a coupon or recipe or other offering.

According to another example embodiment, touch screen coupon offerings may rotate when no one is in front the kiosk.

Thus, there have been described a number of example embodiments of the inventive subject matter.

1. A coupon dispensing system, comprising:
a plurality of dispensing devices located in retail establishments, wherein each dispensing device includes a kiosk unit including:
a) one or more processing units;
b) one or more touch screen displays;
c) a modem and/or network connection;
d) a storage device;
e) one or more printers
a control system capable of exchanging information with the dispensing devices, wherein the control system includes:
a) maintain library of coupon offerings;
b) send coupon offering information to dispensing devices;
c) collect and operate on data received from coupon dispensing devices;
d) provide a web interface accessible over the Internet to provide for viewing of selected dispensing system data; and
a coupon offering authoring tool to prepare coupon offering data to be used to display coupon offerings by the dispensing devices.

2. The system of claim 1 wherein the retail establishment offers a product or service or entertainment to a consumer.

3. A method comprising:
on a coupon dispensing device located in a retail establishment, displaying a selection of coupon offerings on a graphical display, wherein the coupons are for goods or services offered for sale at the retail establishment;
displaying the coupon offerings in one or more groups, wherein one group is displayed at a time; and
a consumer operating the dispensing device to sequence through displays of groups on the display. For example, sequence from group 402 to group 404 to group 406.

4. The method of claim 3 wherein the retail establishment offers a product or service or entertainment to a consumer.

5. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to sequence through displays of groups on the display wherein the offerings having an order in which they are displayed in the groups; and
changing the order of the offerings based on the time of day or day of week or both as previous selection.

6. The method of claim 5 wherein the retail establishment offers a product or service or entertainment to a consumer.

7. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to sequence through displays of groups on the display and selecting one of the coupon offerings to print a corresponding coupon; and
wherein following the selection of the coupon offering displaying a related coupon offering to entice the consumer to select the related coupon offering in addition to the selected coupon offering.

8. The method of claim 7 wherein the retail establishment offers a product or service or entertainment to a consumer.

9. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to sequence through displays of groups on the display wherein the offerings having an order in which they are displayed in the groups; and
changing the order of the offerings based on the location of the device in the establishment.

10. The method of claim 9 wherein the retail establishment offers a product or service or entertainment to a consumer.

11. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to display and select coupon offerings for printing; and
at the request of the retail establishment or a sponsor for a coupon offering substituting a different coupon offering for one of the coupon offerings priorly displayed by the device.

12. The method of claim 11 wherein the retail establishment offers a product or service or entertainment to a consumer.

13. The method of claim 11 wherein printed coupons include a bar code.

14. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to display and select coupon offerings for printing; and
in response to a count of the number of coupons printed for a particular coupon offering stopping the display of the particular coupon offering on the device.

15. The method of claim 14 wherein the retail establishment offers a product or service or entertainment to a consumer.

16. The method of claim 14 wherein printed coupons include a bar code.

17. The method of claim 14 further including substituting a different coupon offering for the particular one for which the display of which was stopped.

18. A method comprising:
on a coupon dispensing device located in a retail establishment, displaying a selection of coupon offerings on a graphical display, wherein the coupons are for goods or services offered for sale at the retail establishment;
displaying the coupon offerings on the device;
a consumer operating the dispensing device and selecting one of the coupon offerings to print a corresponding coupon; and
in addition to printing the coupon selection selected by the consumer, printing one or more related coupons to entice the consumer to use a related coupon in addition to the coupon selected for printing.

19. The method of claim 18 wherein the retail establishment offers a product or service or entertainment to a consumer.

20. The method of claim 18 wherein printed coupons include a bar code.

21. A method comprising:
on a computerized device located in a food service establishment, receiving an electronic order from a consumer who inputs their food service choice into the device;
following entry of the consumer's choice, displaying a selection of coupon offerings on a graphical display, wherein the coupons are for goods or services offered for sale at the food service establishment and which are related to the food choice made by the consumer; and
a consumer operating the dispensing device and selecting one of the coupon offerings to print a corresponding coupon at the device.

22. The method of claim 21 wherein the retail establishment offers a product or service or entertainment to a consumer.

23. The method of claim 21 wherein printed coupons include a bar code.

24. A method according to claim 21 further including selling ad space.

25. A method according to claim 21 further including automatically making ad from advertiser information.

26. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
in an attract mode, displaying a particular set of coupon offerings that are premium in comparison to the other coupon offerings displayed in the two or more groups; and
a consumer operating the dispensing device to sequence through displays of groups on the display wherein the offerings having an order in which they are displayed in the groups.

27. The method of claim 26 wherein the retail establishment offers a product or service or entertainment to a consumer.

28. The method of claim 26 wherein printed coupons include a bar code.

29. A method comprising:
on a coupon dispensing device located in a retail establishment, displaying a selection of coupon offerings on a graphical display, wherein the coupons are for goods or services offered for sale at the retail establishment;
a consumer operating the dispensing device to select a coupon offering for printing;
using a proximity detector on the dispensing device to detect the presence of a consumer at the device; and
associating coupons together that were printed while the proximity detector indicated that a person was in continuous proximity to the device so that coupons selected by the same or what appears to be the same person can be determined.

30. The method of claim 29 wherein the retail establishment offers a product or service or entertainment to a consumer.

31. The method of claim 29 wherein printed coupons include a bar code.

32. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to sequence through displays of groups on the display; and
wherein at least some of the groups of coupon offerings have about 6 to 18 offerings in them and wherein the device permits a consumer to advance from the display of one group to the next by making one input to the device.

33. The method of claim 32 wherein the retail establishment offers a product or service or entertainment to a consumer.

34. The method according to claim 32 further wherein the number of coupon offerings is about 12, the number of groups is about 3 and further wherein the one input is made by pressing a physical button on the device or a button icon on a touch screen display.

35. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to sequence through displays of groups on the display;
wherein there is allocated a desired number of display positions on the display to be used to display the coupon offerings in a group; and
wherein if there are not enough coupon offerings available to display in the total number of display positions available while sequencing through groups of coupon offerings, redisplaying one more or more of the same coupon offerings previously displayed in a different group so that all display groups are filled with a coupon offering.

36. The method of claim 35 wherein the retail establishment offers a product or service or entertainment to a consumer.

37. A method comprising:
on a coupon dispensing device located in a retail establishment, displaying a selection of coupon offerings on a touch-screen graphical display, wherein the coupons are for goods or services offered for sale at the retail establishment;
displaying the coupon offerings in two or more groups, wherein one group is displayed at a time;
a consumer operating a single input mechanism on the dispensing device to sequence through displays of groups on the display; and
a consumer using the touch screen to touch the screen near a displayed coupon offering the consumer wishes to print in order to print the desired coupon offering.

38. The system of claim 37 wherein the retail establishment offers a product or service or entertainment to a consumer.

39. The method of claim 37 wherein printed coupons include a bar code.

40. A method comprising:
on a coupon dispensing device located in a retail establishment, displaying a selection of coupon offerings on a graphical display, wherein the coupons are for goods or services offered for sale at the retail establishment;
displaying the coupon offerings in two or more groups, wherein one group is displayed at a time;
a consumer operating the dispensing device to sequence through displays of groups on the display; and
using a telephone line and modem to periodically download coupon offering data into the dispensing device.

41. The method of claim 40 wherein the retail establishment offers a product or service or entertainment to a consumer.
